(19) United States
(12) Patent Application Publication
(10) Pub. No.: US 2009/0151815 A1
(43) Pub. Date: Jun. 18, 2009

(54) Modular, adaptive funnel with storaging lid

(75) Inventors: Jack Zikeh Peng, Reston, VA (US); Chi-Chung Edward Lee, Reston, VA (US); Nien-Shiang Liu, Silver Spring, VA (US)

Correspondence Address: Jack ZiKeh Peng, 12800 Old Club Lane, Reston, VA, 20191-5856, US

(73) Assignee: Garage and Things Inc., Reston, VA (US)

(21) Appl. No.: 12/314,789

(22) Filed: Dec. 17, 2008

Related U.S. Application Data
(60) Provisional application No. 61/006,081, filed on Dec. 18, 2007.

(51) Int. Cl. B67C 11/00

(52) U.S. Cl. 141/337

(57) ABSTRACT

A funnel that is both functional and storage-efficient is disclosed. A funnel when properly stored takes up no more space than the funnel body itself; when its fully extended can be as long as 30 inches long—longer than any funnel seen in the general consumer market. At its most flexible posture the funnel can be made snake-like to reach the most hard-to reach areas, such as the underside of an automobile or the backside under the kitchen sink.

### CROSS-REFERENCE TO RELATED APPLICATIONS

This application claims priority under 35 U.S.C. 119 to U.S. Provisional Application No. 61/006081, filed on Dec. 18, 2007, the entire content of which is incorporated herein in its entirety.

### FIELD OF THE INVENTION

The present invention relates to funnels and, more particularly, to a funnel that is modular, adaptive for different orifices and capable of neatly storing accessories.

### BACKGROUND OF THE INVENTION

Ever since funneling implements were invented, there has been a need to store the implements cleanly in order to prevent dust or debris which render the funnel un-reusable. An setup that keep the storage volume to the minimum is also essential for easy storage. A modular and adaptive implement makes this possible while allowing multiple usages of one single funnel.

As technology advanced, devices are made more sophisticated, for example, automobiles are packed more densely with components and thus makes some components less accessible with respect to funneling. In the kitchenware arena, there are different orifices that requires different sizes of funnel to satisfy the needs. In the medical field, cleanness of funnel is of utmost importance, a funnel which allows easy and self-contained storage is definitely appealing. With advent of high technology apparatus in modern time, the need for reducing clutter and organizing funneling implements on a typical garage, household kitchen and medical cabinet has increased.

As do-it-yourself mechanics are enjoying working on their automobiles, nothing is more frustrating to find that the nozzle of the funnel at hand does not fit the orifice of the intended work. For example, the funnel purchased for engine oil change can not fit in the opening of the transmission oil inlet. More frustrating yet, the transmission inlet is hidden in a rather obscure area behind the battery and the air filter. A funnel implement which can be extended as long as 30 inches and is made flexible by having elbow functionality on each of the extension segment. Better yet is the nozzle can be exchangeable among three sizes. Once the job is rewardingly finished, the traditional implement of funnel is awkward to store because its long extension takes up shelf space inefficiently. If current implement is left alone on the shelf (however inefficiently), exposed, it can gather enough dust and debris it can make re-usenext time around troublesome. Therefore, the need to have a length-modular and flexible, nozzle-adaptive and storage-efficient is clear.

Inside the kitchen, the probability of needing multiple sizes of funnel is undeniably great. Funnel for transferring spices is different from that for transferring vegetable oil—and one will not mix-use them anyway. So it is not unusual to see multiple funnels with different sizes of nozzles strewn around in the kitchen. How nice will it be if there is a funnel with switch-able nozzle for different occasions? Would it be even better that the funnel stores neatly and space-efficiently as the proposed implement shall demonstrate?.

Finally, in a typically active medical office, storage space efficiency and organization are consistent goals. The self-contained storage feature in the invention can not only save shelf space, increase organization, it keeps the device clean for reuse.

Initially, single-functionality funnels were common. Some addresses the length issue; some addresses the flexibility issue, yet another addresses the cleanness-for-reuse issue by simply having a lid. For various size of orifices, users are forced to buy multiple funnels.

Prior art funnels are inherently single-functioned. As more and more sophisticated requirements are demanded of them they become unattractive for one reason or the other. The customers are frustrated for not having a funnel that can be modular, adaptive and self-contained for storage.

It is an object of the invention to provide a general-purpose funnel.

It is an object of the invention to provide a funnel that is extendable to up to 30 inches.

It is a further object of the invention to provide a funnel whose extension is modular and flexible.

It is an object of the invention to provide a funnel whose nozzles are exchangeable among regular, mid and mini sizes.

It is yet another object of the invention to provide a funnel whose storage is self-contained.

It is yet another object of the invention to provide a funnel whose storage is organized by storage stems implanted on the storage lid.

It is yet another object of the invention to provide a funnel whose storage lid can be snapped-on to the holding tab of the funnel body, by way of buttons.

### SUMMARY OF THE INVENTION

The invention is a funnel that is both functional and storage-efficient. A funnel when properly stored takes up no more space than the funnel body itself; when its fully extended can be as long as 30 inches long—longer than any funnel seen in the general consumer market. At its most flexible posture the funnel can be made snake-like to reach the most hard-to reach areas, such as the underside of an automobile or the backside under the kitchen sink.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a whole funnel extended view of the funnel when it is fully extended with one of the nozzles;

FIG. 2 is the funnel at the flexible posture view of the funnel is demonstrated at a flexible posture;

FIG. 3 is a bottom view of the funnel with the lid attached;

FIG. 4 is a full perspective view of a funnel with all the accessories stored in positions;

FIG. 5 is an outlook view of a funnel in storage posture;

FIG. 6 is a perspective bottom view of a funnel which has the lid taken off (uncovered);

FIG. 7 is a normal usage view of a funnel with the default (un-extended) posture;

FIG. 8 is an accessories view of a funnel with all of its accessories positioned on the lid;

FIG. 9 is a protrusion-on-lid view of a funnel with its lid;

FIG. 10 is the group view of all neck segments;

FIG. 11 is a nozzle-set view of a funnel with all of its adaptive nozzles in display as a set.

For purposes of clarity and brevity, like elements and components will bear the same designations and numbering throughout the Figures.

### DESCRIPTION OF THE PREFERRED EMBODIMENT

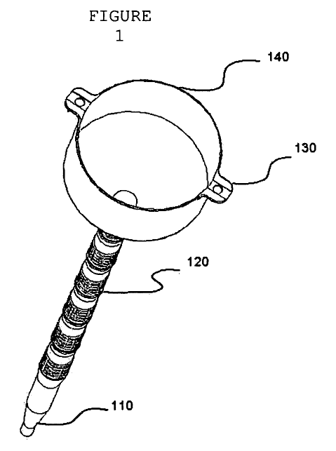

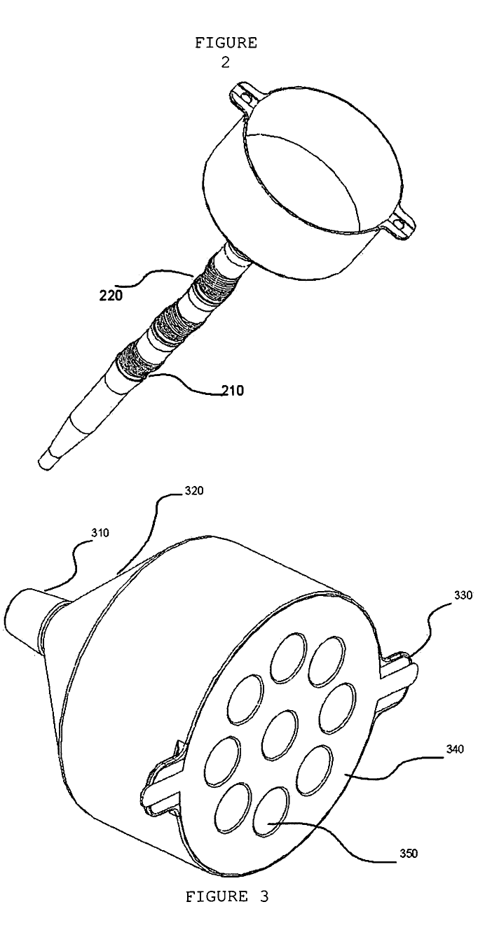

FIG. 1 and FIG. 2 are operation views of a funnel in accordance with the invention. A number of neck segments 120,210,220, are concatenated to show the full extent of the funnel. A funnel body 140 may be fabricated of plastic, stainless steel or glass. Moreover, the main body of the funnel body 140(container) has a stepped contour to fit the shape of a regular engine oil bottle, in the preferred embodiment; while in alternate embodiments, it can also be shaped as a rectangle or inverse triangle or any other geometrical shape deemed to be aesthetically pleasing to the user. An ear tab 130 is a lip-like holding tab for getting hold of the funnel body 140 as well as buttoning up the lid with the funnel body 140. At least one of the neck segments 120 is flexible and bellows-like so the segment can be turned in any direction for about 45 degrees as needed.

FIG. 3 is a bottom view of the funnel with the lid attached. A neck cap 310 is for covering the neck when the funnel is not in use to keep out the dust or debris. A lid 340 is engaged with a larger end of a funnel body 320 to form a storage. A number of protrusions 350 on an inner surface of the lid 340 are used to hold the neck segments. An ear tab 330 is a lip-like holding tab for getting hold of the funnel body as well as buttoning up the lid with the funnel body.

FIG. 4 is a full perspective view of a funnel with all the accessories stored in positions. Each neck segment 450 is connected to the other neck segment 450 by a snap-on or screw-on action. There are multiple neck segments, each can be connected to each other without particular order. At least one of the neck segments 430 is flexible and bellows-like so the segment can be turned in any direction for about 45 degrees as needed. The opening of the nozzle 440 can be one of multiple sizes. The neck cap 410 is for covering the neck when the funnel is not in use. The lid 470 is engaged with the larger end of the funnel body 420 to form the storage. The protrusions 450 on the inner surface of the lid 470 are used to hold the neck segments. The ear tab 460 is a lip-like holding tab for getting hold of the funnel body as well as buttoning up the lid with the funnel body.

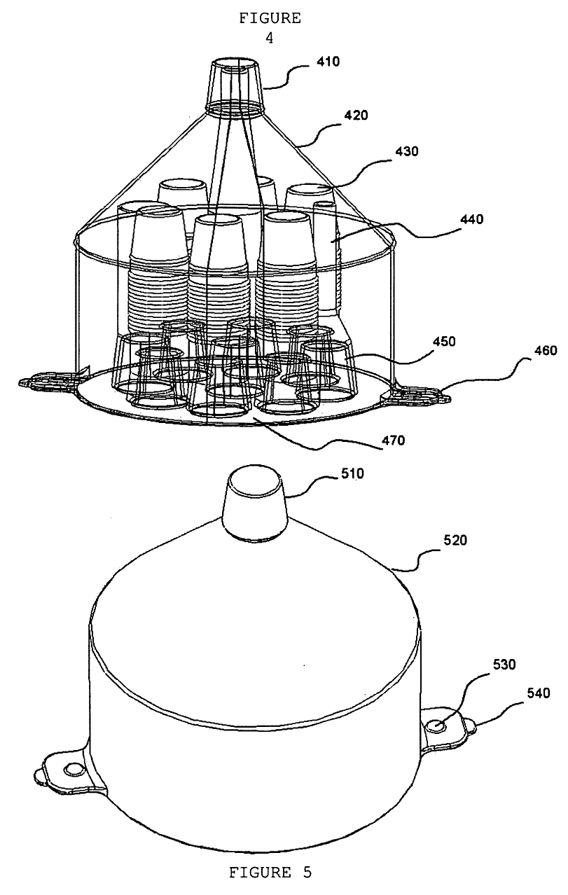

FIG. 5 is an outlook view of a funnel in storage posture. The neck cap 510 is for covering the neck when the funnel is not in use to keep out the dust or debris. The ear tab on the lid 540 is used for buttoning up the lid with the funnel body. The ear tab 530 is a lip-like holding tab for getting hold of the funnel body as well as buttoning up the lid with the funnel body. The funnel body 520 may be fabricated of plastic, stainless steel or glass. Moreover, the main body of the funnel body 520(container) has a stepped contour to fit the shape of a regular engine oil bottle.

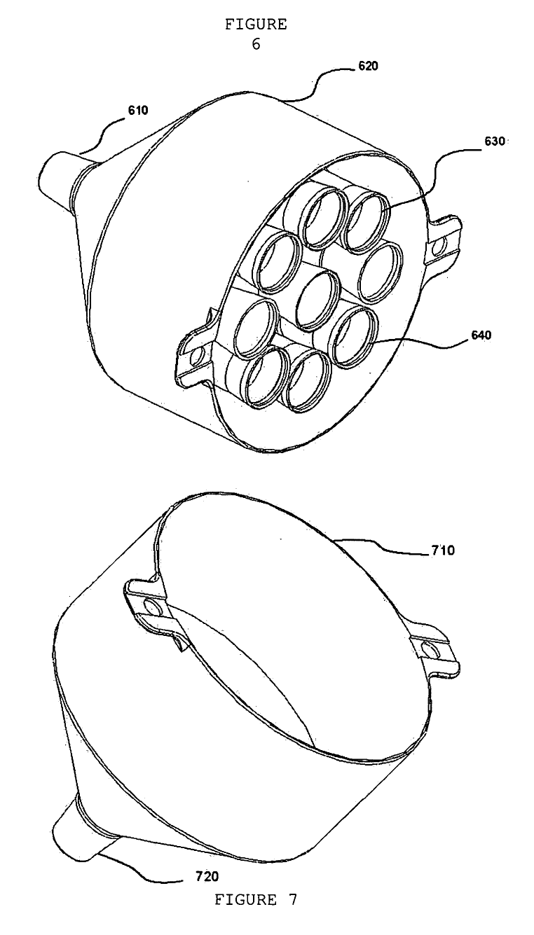

FIG. 6 is a perspective bottom view of a funnel which has the lid taken off (uncovered). The neck cap 610 is for covering the neck when the funnel is not in use. Each neck segment 630 is connected to the other neck segment 630 by a snap-on or screw-on action. There are multiple neck segments, each can be connected to each other without particular order.

FIG. 7 is a normal usage view of a funnel with the default (un-extended) posture. The neck 720 extended from the body 710 and at least one neck segment is attachable with the neck.

FIG. 8 is an accessories view of a funnel with all of its accessories positioned on the lid. Each neck segment 820 is connected to the other neck segment 820 by a snap-on or screw-on action. There are multiple neck segments, each can be connected to each other without particular order. At least one of the neck segments 820 is flexible and bellows-like so the segment can be turned in any direction for about 45 degrees as needed. The opening of the nozzle 810,830 can be one of multiple sizes. The lid 840 is engaged with the larger end of the funnel body to form the storage. The ear tab on the lid 850 is a lip-like holding tab for buttoning up the lid with the funnel body.

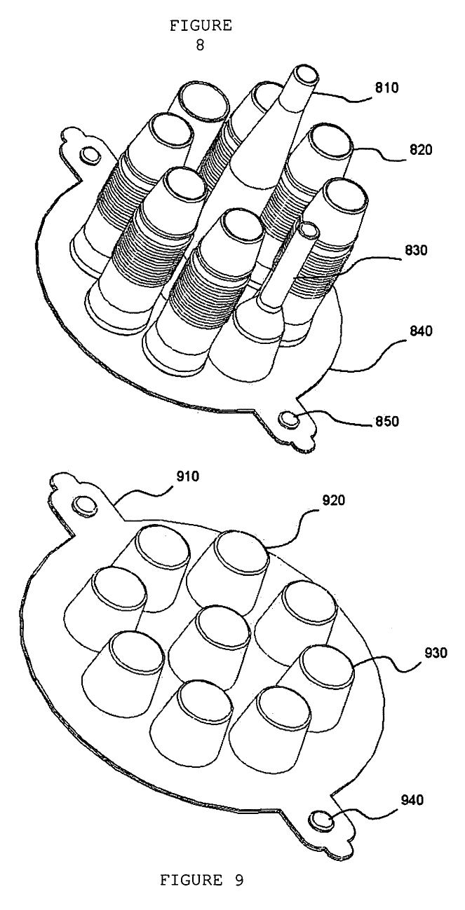

FIG. 9 is a protrusion-on-lid view of a funnel with its lid. The protrusions 920,930 on the inner surface of the lid 910 are used to hold the neck segments. The protrusions are designed to keep the accessories organized and stably in-place. The ear tab on the lid 940 is a lip-like holding tab for buttoning up the lid with the funnel body.

FIG. 10 is the group view of all neck segments. Each neck segment 1010,1020,1030 is connected to the other neck segment 1010,1020,1030 by a snap-on or screw-on action. There are multiple neck segments, each can be connected to each other without particular order. At least one of the neck segments 1010,1020,1030 is flexible and bellows-like so the segment can be turned in any direction for about 45 degrees as needed.

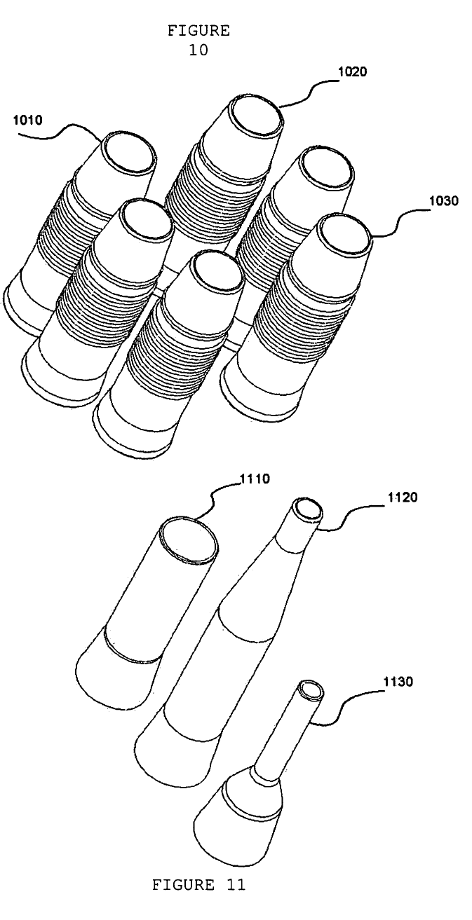

FIG. 11 is a nozzle-set view of a funnel with all of its adaptive nozzles in display as a set. The openings of the nozzles 1110,1120,1130 can be of different sizes as desired. The nozzles 1110,1120,1130 are switch-able, it can be chosen among regular-size nozzle 1110, mid-size nozzle 1120 and mini-size nozzle 1130, the funnel can be used to fit various sizes of receptacle orifice.

Thus, in summary, it can be seen that what is provided in this invention is a funnel that is both functional and storage-efficient. A funnel when properly stored takes up no more space than the funnel body 140 itself; when its fully extended can be as long as 30 inches long—longer than any funnel seen in the general consumer market. At its most flexible posture the funnel can be made snake-like to reach the most hard-to reach areas, such as the underside of an automobile or the backside under the kitchen sink.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

We claim:

1. A modular, extendable funnel, comprising:
a funnel body; and
a neck assembly, comprising a neck extended from the body and at least one neck segment that is separate from the neck and is attachable with the neck.

2. The funnel of claim 1, wherein the at least one neck segment is screwed on the neck.

3. The funnel of claim 1, wherein the at least one neck segment is snapped on the neck.

4. The funnel of claim 2, wherein the neck has threads on the outer circumference that connects with the at least one segment, and the at least one neck segment has threads on the inner circumference that connects with the neck.

5. The funnel of claim 3, wherein the neck and the at least one neck segment have different diameters so that they can be snapped on together.

6. The funnel of claim 1, wherein the at least one neck segment is flexible and bellows-like.

7. The funnel of claim 1, wherein the at least one neck segment includes a female end and a male end.

8. A modular, extendable funnel, comprising:
a funnel body;
a neck assembly connected with the body, wherein the neck assembly is configured to be fitted with at least one size of nozzle.

9. The funnel of claim 8, the neck assembly includes a neck extended from the body and at least one neck segment that is separated from the neck and is attachable with the neck.

10. The funnel of claim 9, wherein the nozzle is fitted in with the at least one neck segment.

11. The funnel of claim 9, wherein the nozzle is snap-on or screw-on type.

12. The funnel of claim 9, wherein the at least one neck segment is flexible and bellows-like.

13. A self-storage funnel, comprising:
a funnel body,
an extendable neck assembly, including at least one neck segment, wherein the at least one neck segment is separated from the funnel body and is attachable with the funnel body; and
a lid for engaging with the larger end of the funnel body so that the funnel body and the lid form a storage.

14. The funnel of claim 13, wherein the lid includes a plurality of protrusions, each of which has a diameter configured to be fitted in an inner circumference of the at least one neck segment.

15. The funnel of claim 13, wherein the plurality of protrusions are formed on a surface of the lid facing an inner side of the funnel body so that when the lid engages with the funnel body, the at least one neck segment is contained in the storage.

16. The funnel of claim 13, wherein the neck assembly includes a neck extended from a smaller end of the body and the funnel further comprising a cap for covering the neck.

17. The funnel of claim 13, wherein the at least one neck segment is flexible and bellows-like.

18. The funnel of claim 13, wherein the neck assembly is configured to be fitted with at least one size of nozzle.
